(19) United States
(12) Patent Application Publication
(10) Pub. No.: US 2007/0152970 A1
(43) Pub. Date: Jul. 5, 2007

(54) Scroll wheel control module of computer mouse

(75) Inventors: Chiu-Wei Chen, Sijhih City (TW); Chien-Ming Su, Sijhih City (TW)

Correspondence Address: BIRCH STEWART KOLASCH & BIRCH, PO BOX 747, FALLS CHURCH, VA, 22040-0747, US

(73) Assignee: Behavior Tech Computer Corp.

(21) Appl. No.: 11/583,160

(22) Filed: Oct. 19, 2006

(30) Foreign Application Priority Data
Jan. 2, 2006 (TW) 095100060

(51) Int. Cl. G09G 5/08

(52) U.S. Cl. 345/163

(57) ABSTRACT

A scroll wheel control module of computer mouse is provided, wherein the computer mouse comprises at least one touch switch capable of generating an electric signal when being touched. The scroll wheel control module includes: a swing structure having at least a scroll wheel, a supporting base for supporting the swing structure such that the swing structure is able to swing on the supporting base, and a touch shaft connected with the swing structure. The touch shaft is for touching the touch switch.

### RELATED APPLICATIONS

The present application is based on, and claims priority from, Taiwan Application Serial Number 95100060, filed Jan. 2, 2006, the disclosure of which is hereby incorporated by reference herein in its entirety.

### BACKGROUND

1. Field of Invention

The present invention relates to a computer mouse.

2. Description of Related Art

FIG. 1 illustrates an exterior structural diagram of a prior art computer mouse (10). As shown in FIG. 1, the scroll wheel (100) is included in the standard specification as well as the left key and the right key. The main operation of the scroll wheel (100) is scrolling forward and backward along the Y-axis, which corresponds to the scrolling of the pages in window operating systems. Besides, the scroll wheel (100) may also adopt a Z-axis pressing function, allowing the user to press down the scroll wheel in order to perform another user-predefined function. For example, the user may click on a file and execute it by pressing the scroll wheel. Afterwards, the scroll wheel (100) bounces back.

However, due to the trend of integrating multiple functions in the electronic technologies, the keys and the scroll wheel upon the operating interface of the conventional computer mouse are no longer sufficient for use. Taking the scroll wheel (100) for example, the operation in the prior art is to scroll forward and backward in the Y-axis, or, added with a Z-axis pressing function at most. Regarding the pressing function in the X-axis, that is, shifting the scroll wheel (100) leftward and rightward in order to trigger a predefined function provided to the user, it is still very rare nowadays, and requiring complicated structure design. Hence the fabrication cost is still high.

For the foregoing reasons, there is a need for a scroll wheel control module applied to the computer mouse in order to improve the utilization of the scroll wheel of the computer mouse, hence to increase the value of utilization for the scroll wheel of the computer mouse.

### SUMMARY

It is provided in the present invention a scroll wheel control module applicable to the computer mouse. The present invention enables the pressing function of the scroll wheel of the mouse in multiple directions, hence increase the value of the scroll wheel of the computer mouse. It is also provided in the present invention a scroll wheel control module applied in the computer mouse. The design of the introduced scroll wheel control module is concise, hence the fabrication cost is decreased effectively.

It is therefore an aspect of the present invention to provide a scroll wheel control module of computer mouse, wherein the computer mouse comprises at least one touch switch capable of generating an electric signal when being touched. The scroll wheel control module includes: a swing structure, a supporting base and a touch shaft. The swing structure includes at least a scroll wheel. The supporting base is for supporting the swing structure such that the swing structure is able to swing on the supporting base. And the touch shaft is connected with the swing structure for touching the touch switch.

Further, the swing structure may further include a carrier for carrying the scroll wheel. Therefore, the supporting base is utilized to support the carrier and allow the carrier to swing thereon.

These and other features, aspects, and advantages of the present invention will become better understood with reference to the following description, figures, and appended claims.

It is to be understood that both the foregoing general description and the following detailed description are by examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 is an exterior structural diagram of a computer mouse in the prior art;

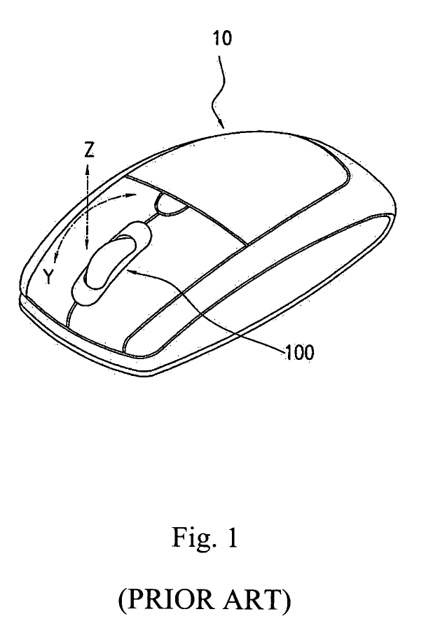

FIG. 2A is a pictorial decomposition chart according to an embodiment of the present invention;

FIG. 2B is an assembly diagram of FIG. 2A;

FIG. 2C is an assembly diagram of FIG. 2A with another angle of vision;

FIG. 3A is a pictorial decomposition chart according to another embodiment of the present invention;

FIG. 3B is an assembly diagram of FIG. 3A;

FIG. 3C is an assembly diagram of FIG. 2A with another angle of vision;

FIG. 4A is a pictorial decomposition chart according to still another embodiment of the present invention;

FIG. 4B is an assembly diagram of FIG. 4A;

FIG. 4C is an assembly diagram of FIG. 4A with another angle of vision;

FIG. 5A is a pictorial decomposition chart according to yet another embodiment of the present invention; and

FIG. 5B is an assembly diagram of FIG. 5A.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

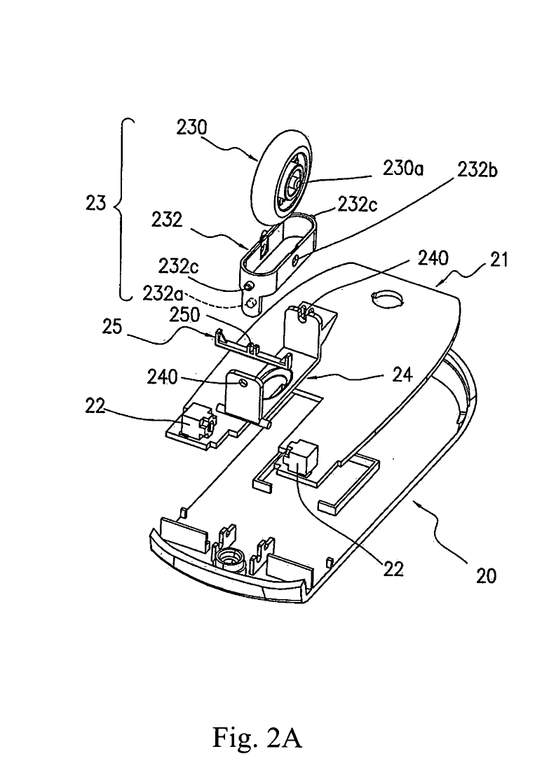

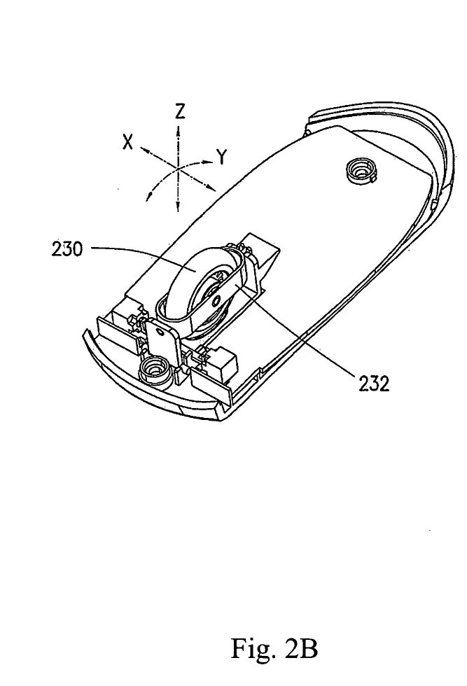

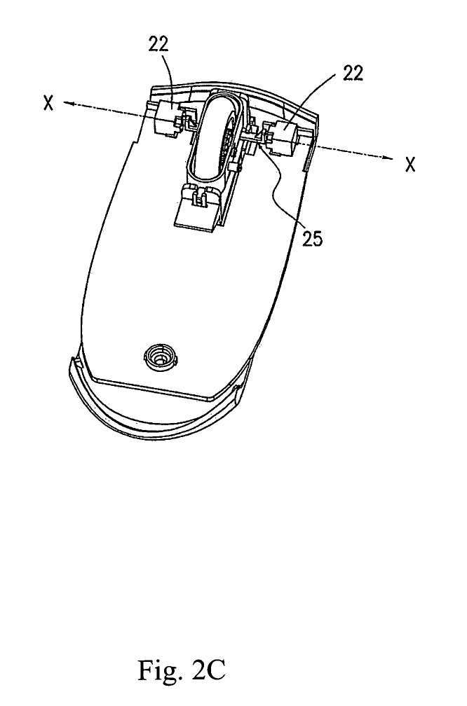

FIG. 2A shows a pictorial decomposition chart according to an embodiment of the present invention. Referring to FIG. 2A, the computer mouse applicable to the present invention includes a base (20), a circuit board (21) and a plurality of touch switches (22) capable of generating an electronic signal when being touched. The scroll wheel control module of the present invention includes: a swing structure (23), a supporting base (24), and a touch shaft (25). These components are demonstrated in details as below.

The swing structure (23) comprises the scroll wheel (230) and the carrier (232), wherein the carrier (232) is utilized to carry the scroll wheel (230). As illustrated in FIG. 2A, the carrier (232) is a hallow pillar with a plurality of holes (232b) installed initially for a bearing (230a) of the scroll wheel (230) to pass through. In addition, the carrier (232) includes a horizontal bearing (232c) and a first protrusion (232a) simultaneously, wherein the related purpose and the operation are described in the following.

The supporting base (24) is utilized to support the swing structure (23), allowing the swing structure (23) to swing thereon. Specifically, referring to the embodiment shown in FIG. 2A, the supporting base (24) is utilized to support the carrier (232) of the swing structure (23), allowing the carrier (232) to swing thereon. There is a plurality of carrying parts (240) installed on the supporting base (24) for carrying the horizontal bearing (232c).

The touch shaft (25) is connected to the swing structure (23), for touching the touch switch (22). Similarly, referring to the embodiment displayed in FIG. 2A, the touch shaft (25) includes a first U-shaped component (250) for coupling to the first protrusion (232a) of the carrier (232) such that the touch shaft (25) and the swing structure (23) are coupled.

FIG. 2B is an assembly diagram of FIG. 2A, and FIG. 2C is an assembly diagram of FIG. 2A with another angle of vision. Referring to FIG. 2B, the swing structure (23) comprising the scroll wheel (230) and the carrier (232) is able to shift leftward and rightward in the X-axis direction. When the swing structure (23) shifts leftward and rightward, the touch shaft (25) is pushed forward to shift leftward and rightward in the X-axis direction, as illustrated in FIG. 2C. Hence an end of the touch shaft (25) touches the touch switch (22) in accordance. Referring to FIG. 2C, the two touch switches (22) are disposed at the left side and the right side of the touch shaft (25) respectively and along the same horizontal direction as the touch shaft (25).

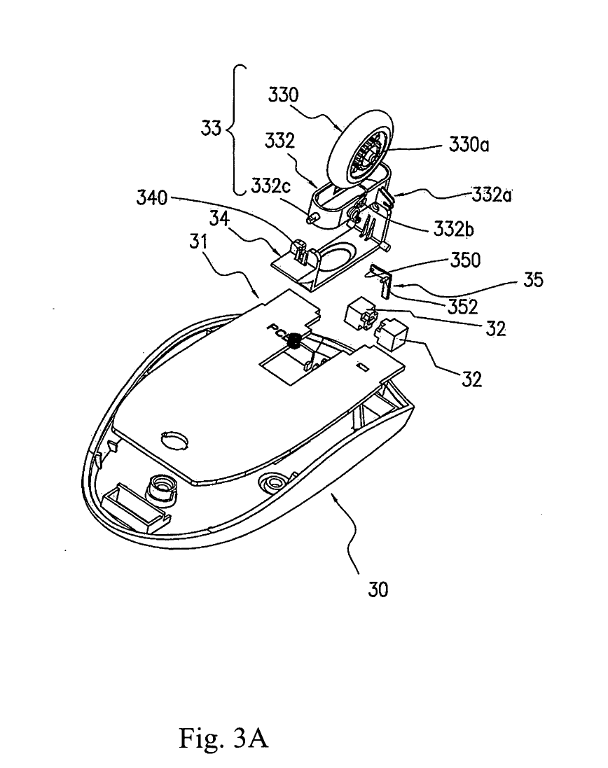

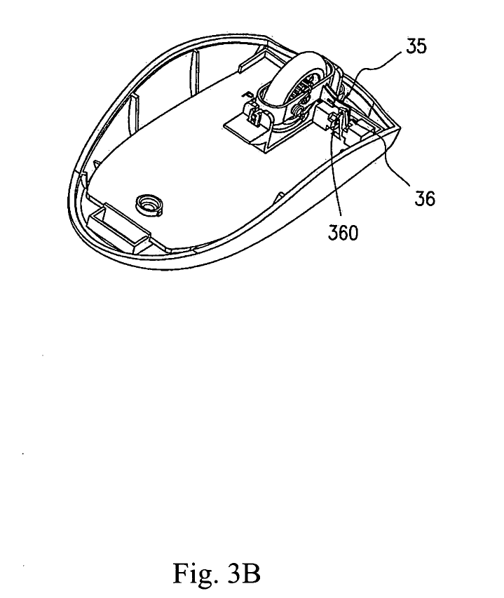

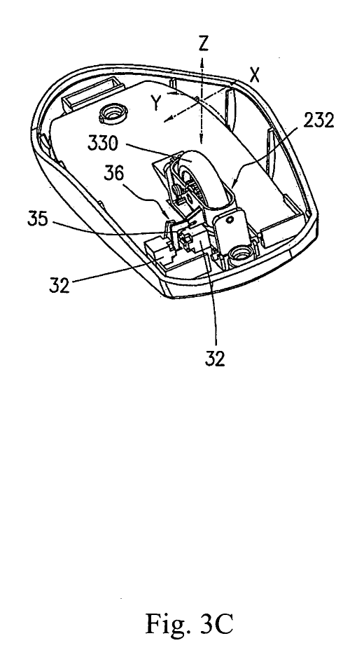

FIG. 3A displays a pictorial decomposition chart according to another embodiment of the present invention. Referring to FIG. 3A, the computer mouse applicable to the present invention includes a base (30), a circuit board (31) and a plurality of touch switches (32) capable of generating an electrical signal when being touched. The scroll wheel control module of the present invention includes: a swing structure (33), a supporting base (34), and a touch shaft (35). These components are described in details in the following paragraphs.

The swing structure (33) comprises the scroll wheel (330) and the carrier (332), wherein the carrier (332) is utilized to carry the scroll wheel (330). As illustrated in FIG. 3A, the carrier (332) is a hallow pillar with a plurality of holes (332b) installed initially for a bearing (330a) of the scroll wheel (330) to pass through. In addition, the carrier (332) includes a horizontal bearing (332c) and a second protrusion (332a) as well, wherein the purpose and the operation are described in the following.

The supporting base (34) is utilized to support the swing structure (33), allowing the swing structure (33) to swing thereon. Specifically, referring to the embodiment illustrated in FIG. 3A, the supporting base (34) is utilized to support the carrier (332) of the swing structure (33), and allow the carrier (332) to swing thereon. There is a plurality of carrying parts (340) installed on the supporting base (34) for carrying the horizontal bearing (332c).

The touch shaft (35) is connected to the swing structure (33), for touching the touch switch (32). Similarly, referring to the embodiment shown in FIG. 3A, the touch shaft (35) includes a second protrusion (350) for pivotally jointing the second U-shaped component (332a) of the carrier (332) in order to couple the touch shaft (35) and the swing structure (33). In addition, the touch shaft (35) further includes a third protrusion (352), of which the purpose and operation are described as follows.

FIG. 3B is an assembly diagram of FIG. 3A. The scroll wheel control module of the present invention further includes a supporting frame (36) with a hole (360) installed initially for supporting the touch shaft (35). The third protrusion (352) of the touch shaft (35) is capable of pivotally jointing the hole (360) installed on the supporting frame (36) such that the touch shaft (35) can swing.

FIG. 3C is an assembly diagram of FIG. 3A with another angle of vision. Referring to FIG. 3C, the touch shaft (35) is of a shape of L, hanging on the supporting frame (36) inversely. Moreover, an end of the touch shaft (35) is disposed along a horizontal direction of the touch switch (32), between the two touch switches (32). As illustrated in FIG. 3C, the swing structure (33), comprising the scroll wheel (330) and the carrier (332), is able to shift leftward and rightward in the X-axis direction. When the swing structure (33) shifts leftward and rightward, the touch shaft (35) is pushed forward to shift leftward and rightward in the X-axis direction, as illustrated in FIG. 3C, and an end of the touch shaft (35) is pulled to touch either one of the touch switches (32) further.

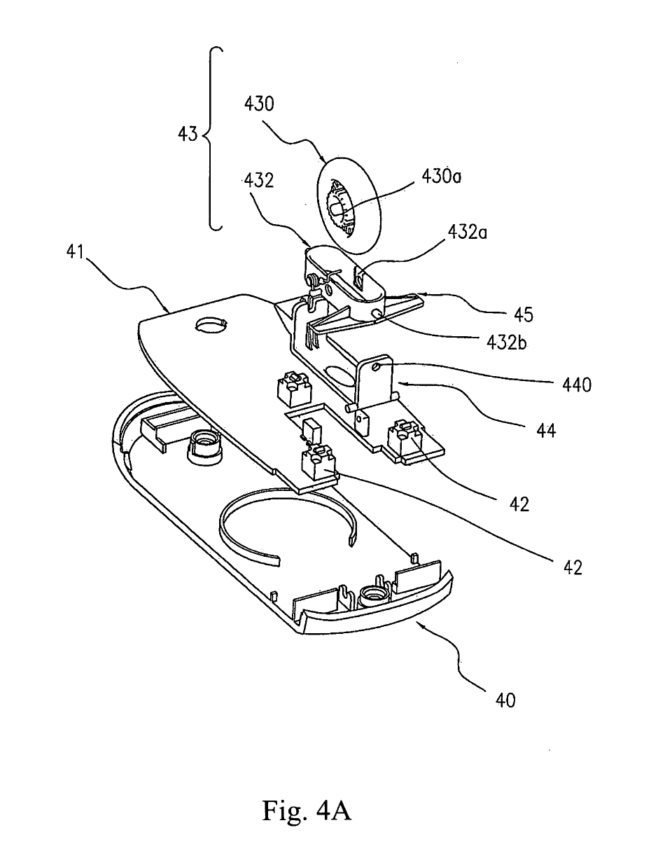

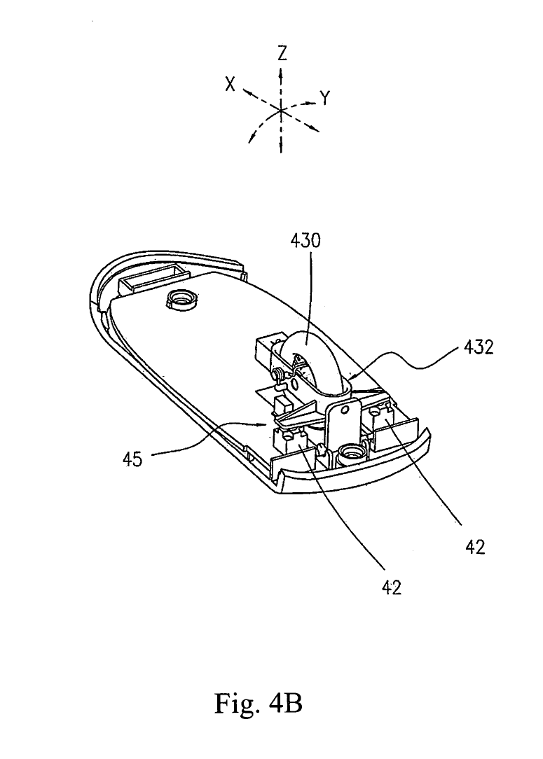

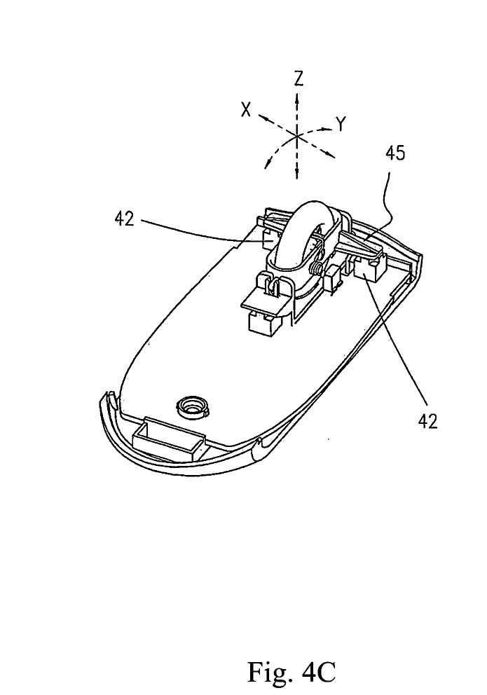

FIG. 4A shows a pictorial decomposition chart according to still another embodiment of the present invention. Referring to FIG. 4A, the computer mouse applicable to the present invention includes a base (40), a circuit board (41) and a plurality of touch switches (42) capable of generating an electrical signal when being touched. The scroll wheel control module of the present invention includes: a swing structure (43), a supporting base (44), and a touch shaft (45). These components are described in details in the following paragraphs.

The swing structure (43) comprises the scroll wheel (430) and the carrier (432), wherein the carrier (432) is utilized to carry the scroll wheel (430). As illustrated in FIG. 4A, the carrier (432) is a hallow pillar with a plurality of holes (432a) installed initially for a bearing (430a) of the scroll wheel (430) to pass through. In addition, the carrier (432) includes a horizontal bearing (432b) as well, wherein the purpose and the operation are described in the following.

The supporting base (44) is utilized to support the swing structure (43), allowing the swing structure (43) to swing thereon. Specifically, referring to the embodiment in FIG. 4A, the supporting base (44) is utilized to support the carrier (432) within the swing structure (43), and allow the carrier (432) to swing thereon. There is a plurality of carrying parts, i.e. a hole (440) or a concave portion (442), installed on the supporting base (44) for carrying the horizontal bearings (432b) of the carrier (432).

The touch shaft (45) is connected to the swing structure (43), for touching the touch switches (42). Similarly, referring to the embodiment shown in FIG. 4A, the touch shaft (45) is fixed on the carrier (432), such that the touch shaft (45) is connected to the swing structure (43).

FIG. 4B is an assembly diagram of FIG. 4A, while FIG. 4C is an assembly diagram of FIG. 4A with another angle of vision. Referring to FIG. 4B, the swing structure (43), comprising the scroll wheel (430) and the carrier (432), is able to shift leftward and rightward in the X-axis direction. When the swing structure (43) shifts leftward and rightward, the touch shaft (45) at both sides is pushed to swing upward and downward, as illustrated in FIG. 4C. Furthermore, an end of the touch shaft (45) is pulled to touch the touch switches (42) in accordance. Referring to FIG. 4C, an end of the touch shaft (45) is disposed along a vertical direction of the touch switches (42).

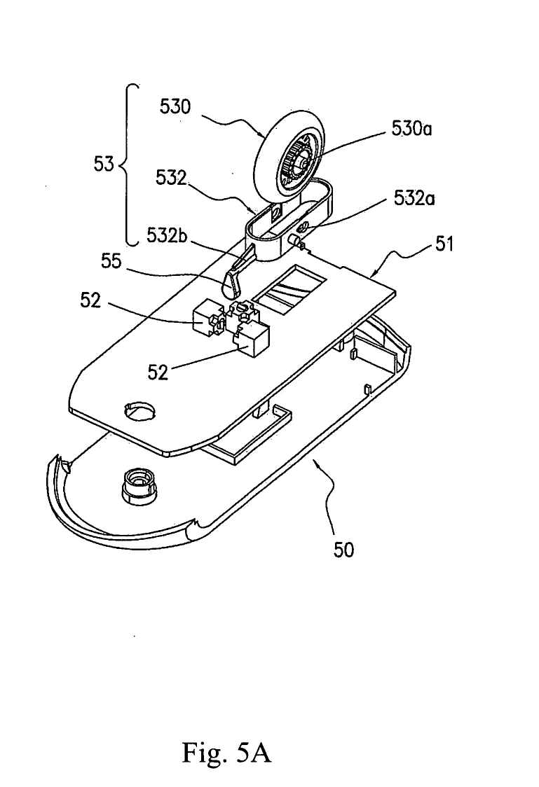

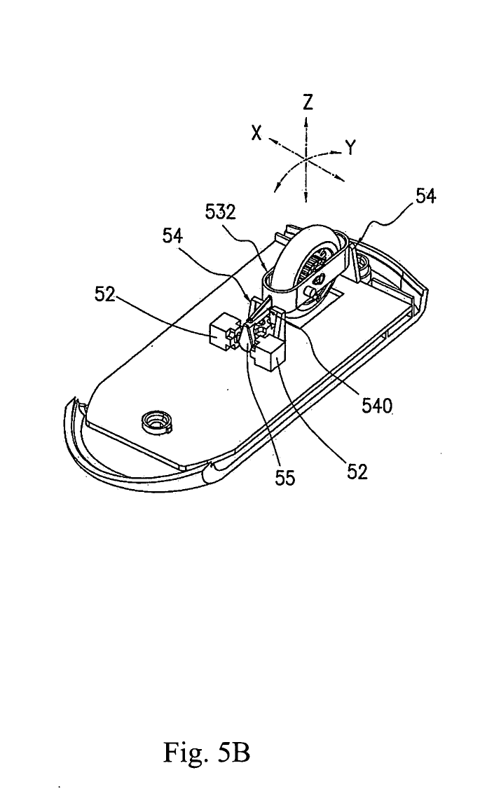

FIG. 5A shows a pictorial decomposition chart according to yet another embodiment of the present invention, and FIG. 5B is an assembly diagram of FIG. 5A. Referring to FIG. 5A and 5B, the computer mouse applicable to the present invention includes a base (50), a circuit board (51) and a plurality of touch switches (52) capable of generating an electrical signal when being touched. The scroll wheel control module of the present invention includes: a swing structure (53), a supporting base (54), and a touch shaft (55). These components are described in details in the following paragraphs.

The swing structure (53) comprises the scroll wheel (530) and the carrier (532), wherein the carrier (532) is utilized to carry the scroll wheel (530). As illustrated in FIG. 5A, the carrier (532) is a hallow pillar with a plurality of holes (532a) installed initially for a bearing (530a) of the scroll wheel (530) to pass through. In addition, the carrier (532) includes a horizontal bearing (532b) as well, wherein the purpose and the operation are described in the following.

The supporting base (54) is utilized to support the swing structure (53), allowing the swing structure (53) to swing thereon. Specifically, referring to the embodiment displayed in FIG. 5B, the supporting base (54) is utilized to support the carrier (532) of the swing structure (53), and allow the carrier (532) to swing thereon. There is a plurality of carrying parts, i.e. a concave portion (540), installed on the supporting base (54) for carrying the horizontal bearing (532b) of the carrier (532).

The touch shaft (55) is connected to the swing structure (53), for touching the touch switch (52). Similarly, referring to the embodiment shown in FIG. 5A, the touch shaft (55) is of a shape of a fan, immovably installed on the horizontal bearing (532b) of the carrier (532) in order to couple the touch shaft (55) and the swing structure (53).

FIG. 5B is an assembly diagram of FIG. 5A. Referring to FIG. 5B, the swing structure (53), comprising the scroll wheel (530) and the carrier (532), is able to shift leftward and rightward in the X-axis direction. When the swing structure (53) shifts leftward and rightward, the touch shaft (55) at both sides is pushed forward to shift leftward and rightward in the X-axis direction, and an end of the touch shaft (55) is pulled to touch the touch switches (52) further. Referring to FIG. 5B, an end of the touch shaft (55) is disposed along a horizontal direction of the touch switches (52) and is set between the two touch switches (52).

Although the present invention has been described in considerable details with reference to certain preferred embodiments thereof, other embodiments are possible. Their spirit and scope of the appended claims should not be limited to the description of the preferred embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A scroll wheel control module of computer mouse, wherein the computer mouse comprises at least one touch switch capable of generating an electric signal when being touched, the scroll wheel control module comprising:
a swing structure, comprising at least a scroll wheel;
a supporting base, for supporting the swing structure such that the swing structure is able to swing on the supporting base; and
a touch shaft, connected with the swing structure, the touch shaft being in contact with the touch switch when the swing structure swings.

2. The scroll wheel control module of claim 1, wherein the swing structure further comprises a carrier for carrying the scroll wheel.

3. The scroll wheel control module of claim 2, wherein the supporting base is for supporting the carrier such that the carrier is able to swing on the supporting base.

4. The scroll wheel control module of claim 3, wherein the touch shaft comprises a first U-shaped component.

5. The scroll wheel control module of claim 4, wherein the carrier comprises a first protrusion coupling to the first U-shaped component.

6. The scroll wheel control module of claim 2, wherein the carrier is a hallow pillar having a plurality of holes to couple a bearing of the scroll wheel to pass through.

7. The scroll wheel control module of claim 3, wherein the carrier comprises a horizontal bearing.

8. The scroll wheel control module of claim 7, wherein the supporting base has a plurality of carrying parts to carry the horizontal bearing.

9. The scroll wheel control module of claim 3, wherein the carrier comprises a second U-shaped component.

10. The scroll wheel control module of claim 9, wherein the touch shaft comprises a second protrusion pivotally jointing the second U-shaped component.

11. The scroll wheel control module of claim 10, further comprising a supporting frame having a hole to support the touch shaft.

12. The scroll wheel control module of claim 11, wherein the touch shaft comprises a third protrusion pivotally jointing the hole of the supporting frame.

13. The scroll wheel control module of claim 12, wherein the touch shaft is of an L shape, hanging on the supporting frame inversely.

14. The scroll wheel control module of claim 3, wherein the touch shaft is immovably installed on the carrier.

15. The scroll wheel control module of claim 7, wherein the touch shaft is immovably installed on the horizontal bearing of the carrier.

16. The scroll wheel control module of claim 15, wherein the touch shaft is of a shape of a fan.

17. The scroll wheel control module of claim 1, wherein an end of the touch shaft is disposed along a horizontal direction of the touch switch.

18. The scroll wheel control module of claim 1, wherein an end of the touch shaft is disposed along a vertical direction of the touch switch.
